(19) United States
(12) Patent Application Publication
(10) Pub. No.: US 2026/0032788 A1
(43) Pub. Date: Jan. 29, 2026

(54) SEGMENTED ELECTRICAL FEEDTHROUGH

(71) Applicant: Schaeffler Technologies AG & Co. KG, Herzogenaurach (DE)

(72) Inventors: Rolf BRÜCK, Bergisch Gladbach (DE); Peter HIRTH, Rösrath (DE); Michael VOIT, Leverkusen (DE); Ferdi KURTH, Mechernich (DE); Stefan AHLERS, Bergisch Gladbach (DE)

(21) Appl. No.: 18/996,244

(22) PCT Filed: Jul. 10, 2023
(86) PCT No.: PCT/EP2023/069086

§ 371 Date: Jan. 17, 2025

(30) Foreign Application Priority Data
Jul. 21, 2022 (DE) 10 2022 207 488.2

(51) Int. Cl. H05B 3/08; H01R 4/02

(52) U.S. Cl. CPC H05B 3/08; H01R 4/024

(57) ABSTRACT

A segmented electrical feedthrough for electrically contacting a heating conductor through a housing, having a heating conductor and an insulating portion. The insulating portion has an electrical conductor, an insulator, and an outer sleeve, wherein the electrical conductor and the insulator are arranged within the outer sleeve and the electrical conductor is electrically insulated with respect to the outer sleeve by the insulator. The heating conductor is connected to the electrical conductor at a predefinable angle and the heating conductor and the insulating portion are formed from two different elements that are permanently connected to one another by a joining method, wherein the heating conductor has a recess into which the electrical conductor of the insulating portion is able to be introduced.

### CROSS REFERENCE TO RELATED APPLICATIONS

This is a U.S. national stage of Application No. PCT/EP2023/069086 filed Jul. 10, 2023. Priority is claimed on German Application No. DE 10 2022 207 488.2 filed Jul. 21, 2022, the contents of which are incorporated herein by reference.

### BACKGROUND OF THE INVENTION

### 1. Field of the Invention

The disclosure relates to a segmented electrical feedthrough for electrically contacting a heating conductor through a housing, comprising a heating conductor and an insulating portion, wherein the insulating portion has an electrical conductor, an insulator and an outer sleeve, wherein the electrical conductor and the insulator are arranged within the outer sleeve and the electrical conductor is electrically insulated with respect to the outer sleeve by the insulator, wherein the heating conductor is connected to the electrical conductor at a predefinable angle.

### 2. Description of the Related Art

Nowadays, electrical heating elements are regularly used to heat exhaust gases in an exhaust gas tract downstream of an internal combustion engine, or the exhaust gas flowing in an exhaust gas tract. The aim here is to more quickly attain a temperature threshold from which effective transformation of the pollutants entrained in the exhaust gas is possible. This is necessary since the catalytically active surfaces, which are used for exhaust gas aftertreatment, of the catalytic converters installed in the exhaust gas tract only enable sufficient conversion of the respective pollutants from a minimum temperature, which is known as the light-off temperature.

The known solutions in the prior art include what are known as heated catalytic converters, which have a metallic structure connected to a voltage source or a metal-coated ceramic structure, which can be heated up by exploiting ohmic resistance.

For the purpose of electrically contacting the heatable structure, it is necessary to introduce an electrical conductor through the housing of the exhaust gas tract or of a catalytic converter arranged in the exhaust gas tract at at least one point. It is necessary in this case to ensure that the feedthrough is gas-tight, and also that there is electrical insulation between the housing and the electrical conductor, and that sufficient durability is assured. The electrical conductor is regularly formed from a solid material, such as a metal bolt.

Document DE 10 2012 110 098 B4 discloses a method for producing an electrical feedthrough for the power supply of an electrical exhaust gas heating system in a motor vehicle. The feedthrough has an outer tube, with an electrical conductor passing through the interior thereof. The electrical conductor protrudes beyond the outer tube at at least one of the end faces of the outer tube. The electrical conductor is surrounded in the interior of the outer tube by an insulating material. The feedthrough is generated here by trimming a compressed rod material to length, wherein in each case regions of the portion functioning as the outer tube and of the portion functioning as the insulating material are removed by machining methods in order to thus generate an electrical feedthrough of the desired length with a desired projection of the electrical conductor beyond the outer tube.

A disadvantage of the methods known in the prior art for producing an electrical feedthrough is in particular that the compressed rod material used is very expensive, as it has a multi-layer structure. In addition, the machining to release the electrical conductor and to trim the electrical feedthrough to length destroys, and therefore wastes, a significant proportion of approximately two-thirds of the rod material unused by machining. The production process is therefore particularly complex and cost-intensive.

### SUMMARY OF THE INVENTION

An object of one aspect of the present invention is therefore to provide a segmented electrical feedthrough and a suitable production method that allows a simplified and cost-effective production of the electrical feedthrough, with technical properties that are at least equally as good.

aspect of the invention relates to a segmented electrical feedthrough for electrically contacting a heating conductor through a housing, comprising a heating conductor and an insulating portion, wherein the insulating portion has an electrical conductor, an insulator and an outer sleeve, wherein the electrical conductor and the insulator are arranged within the outer sleeve and the electrical conductor is electrically insulated with respect to the outer sleeve by the insulator, wherein the heating conductor is connected to the electrical conductor at a predefinable angle, wherein the heating conductor and the insulating portion are formed from two different elements that are permanently connected to one another by a joining method, wherein the heating conductor has a recess into which the electrical conductor of the insulating portion is able to be introduced.

The electrical feedthrough is used to guide an electrical conductor through a housing of an exhaust gas line or a catalytic converter. The feed-through has to be resistant to the temperatures occurring and be gas-tight so that no exhaust gas is able to escape. The electrical conductor should be electrically isolated from the housing so that a short circuit is not able to occur.

The insulating portion of the segmented feedthrough is designed to enable an outwardly electrically insulated feedthrough of the electrical conductor through a housing of a catalytic converter or an exhaust gas line. To this end, the outer sleeve is able to be permanently connected, for example welded, to the housing. The insulator that is arranged coaxially around the electrical conductor, isolates the electrical conductor from the outer sleeve.

The electrical conductor is electrically conductively connected to the heating conductor of the segmented electrical feedthrough. According to the invention, the electrical conductor and the heating conductor, which are preferably formed by metal bolts, are connected to one another at a predefinable angle with respect to one another. This means in particular that the electrical conductor and the heating conductor are not connected to one another at their end sides, but rather the electrical conductor is preferably connected to a lateral outer face of the heating conductor. Such an angled design can create particularly space-saving designs, which are very advantageous particularly in the context of the installation space that is often very limited.

The heating conductor preferably has a recess, for example a hole, in which the electrical conductor is able to be inserted and is able to be permanently connected to the heating conductor. By way of example, the recess on the heating conductor is able to form a press fit with the electrical conductor. By way of example, the recess is also able to taper conically, so that the force generated by the insertion and acting on the electrical conductor in the radial direction is increased as the insertion depth increases.

The electrical conductor and the heating conductor are preferably able to be welded or soldered to one another.

It is particularly advantageous for the heating conductor to have a solder reservoir within the recess. This is particularly advantageous in order to provide the solder material required for a solder connection and therefore to generate the solder connection in a particularly simple manner. The solder reservoir is preferably dimensioned in such a way that a sufficient amount of solder is able to be provided to generate a surface connection between the electrical conductor and the heating conductor over the entire surface.

It is also advantageous for the recess to be formed by a hole, wherein the solder reservoir is formed on the end face, which is formed in the heating conductor, of the hole. To this end, by way of example, the hole may have a further small recess, which forms the actual solder reservoir.

One preferred aspect of the invention is characterized in that the recess tapers conically from the opening to the end face of the hole. This is advantageous in order, by the insertion, to achieve a particular clamping effect between the electrical conductor and the heating conductor, and therefore to create a stronger connection.

It is also preferable for the central axis of the heating conductor to be arranged at an angle of 60 degrees to 120 degrees, particularly preferably of approximately 90 degrees, with respect to the central axis of the electrical conductor. In particular, a connection at an angle of 90 degrees with respect to one another is advantageous in order to create the most compact design possible. In the case of a connection created at an angle different to 90 degrees, the central axis of the hole forming the recess may also be tilted by the corresponding angle to ensure a connection with an accurate fit at the desired angle.

In addition, it is advantageous for the insulating portion to have a multi-part design, wherein, in particular, the electrical conductor is divided, at least in two parts. The insulating portion is preferably able to have a multi-part design. This makes it easier to install the electrical feedthrough. The part of the insulating portion, in particular of the electrical conductor in the insulating portion, that functions as a contact to the heating conductor is designed to be separate from the part of the electrical conductor that is arranged between the insulator.

These two parts may be aligned with one another during manufacture, if necessary, with the aid of an auxiliary tool and, for example, selectively fixed with respect to one another by welded connections. In a subsequent soldering method, both parts are then able to be connected to one another over the entire surface. To this end, one of the two parts preferably has a solder reservoir that is large enough to accommodate the required amount of solder. By way of example, the solder reservoir may be formed by a hole in the electrical conductor.

Furthermore, it is advantageous for the parts of the electrical conductor to be able to be inserted into one other and to be able to be permanently connected to one other by means of a joining method. Inserting them into one another makes it possible to position the two parts relative to one another in a simple way. A solder reservoir is able to be provided on one of the parts in order to create a permanent connection by a soldering process.

It is also expedient for at least one of the parts of the electrical conductor to have a solder reservoir, wherein the solder reservoir is arranged in an area at which the two parts of the electrical conductor are in contact with one another.

In addition, it is advantageous for the solder reservoir to be large enough for the two parts of the electrical conductor to be able to be soldered to one another over the entire surface.

One aspect of the invention relates to a method for producing a segmented electrical feedthrough, wherein the two parts of the electrical conductor are fixed with respect to one another by a welding method, wherein the two parts of the electrical conductor are connected to one another, and the electrical conductor itself is connected to the heating conductor, by a downstream soldering method. In this way, the electrical feedthrough is able to be produced in a simple way and is able to be used advantageously in particular in confined spatial conditions.

Advantageous developments of the present invention are described in the dependent claims and in the following description of the figures.

### BRIEF DESCRIPTION OF THE DRAWINGS

The invention is explained in detail below on the basis of exemplary embodiments with reference to the drawings, in which:

FIG. 1 is a segmented electrical feedthrough, wherein the electrical conductor has a one-part design and is able to be connected to the heating conductor at an angle of, for example, 90 degrees, and

FIG. 2 is a segmented electrical feedthrough, wherein the electrical conductor has a multi-part design and is able to be connected to the heating conductor at a predefinable angle.

### DETAILED DESCRIPTION OF THE PRESENTLY PREFERRED EMBODIMENTS

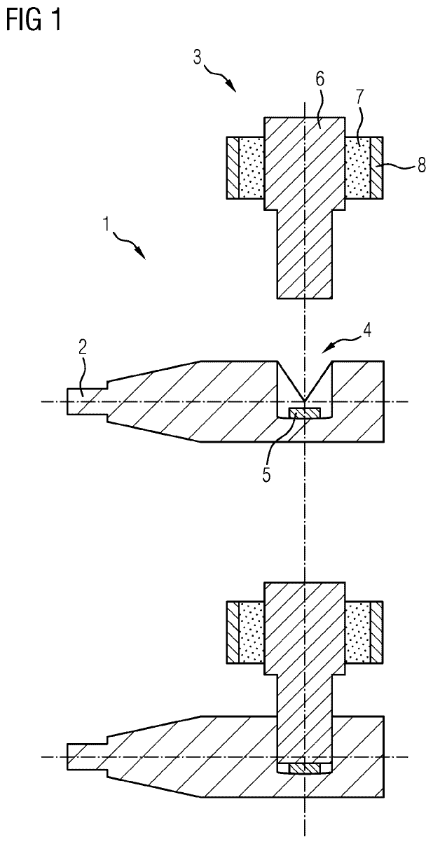

FIG. 1 shows a segmented electrical feedthrough 1, wherein the feedthrough 1 has a heating conductor 2 and an insulating portion 3. The heating conductor 2 is in the form of a metal bolt and has a recess 4 extending in the radial direction of the heating conductor 2. By way of example, the recess 4 can be created by a hole. A solder reservoir 5 that is able to receive a defined amount of solder, which is used to solder the heating conductor 2 to the electrical conductor 6 of the insulating portion 3, is provided in the bottom of the recess 4.

In the upper part of FIG. 1, the heating conductor 2 is shown separately from the insulating portion 3. The insulating portion 3 has a central electrical conductor 6 that is enclosed coaxially by an insulator 7, for example an oxide ceramic. The insulator 7 is followed by an outer sleeve 8, which is preferably metal and may be used to connect the feedthrough 1 to an external housing.

In the lower part of FIG. 1, the electrical conductor 6 is inserted into the recess 4 and a connection between the insulating portion 3 and the heating conductor 2 has thus been generated.

Designing the recess 4 in such a way that it extends in the radial direction of the heating conductor 2 makes it possible for the insulating portion 3 to be arranged at an angle of 90 degrees with respect to the central axis of the heating conductor 2.

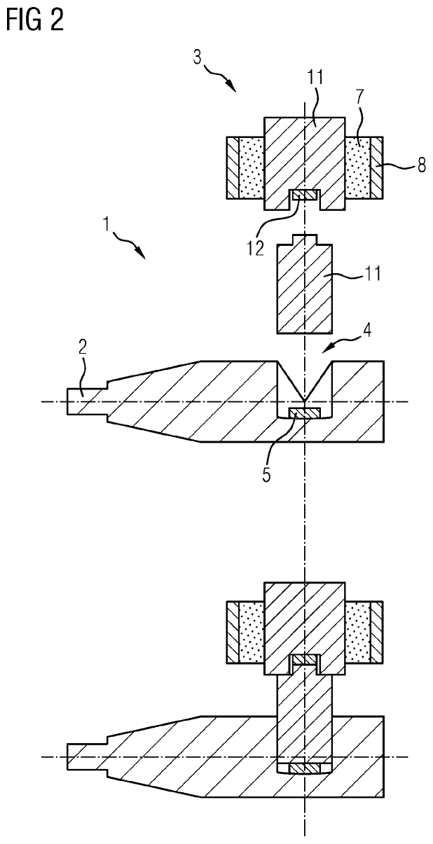

FIG. 2 shows a similar electrical feedthrough 10, wherein, in contrast to FIG. 1, the electrical conductor 11 has a two-part configuration. In the upper part of FIG. 2, the electrical conductor 11 has a plug connection 12, wherein a solder reservoir is provided in the recess of the plug connection 12. A permanent connection is able to be created as a result of inserting the two parts of the electrical conductor 11 into one another and subsequent soldering.

The lower part of the electrical conductor 11 is connected to the heating conductor 2 as in the exemplary embodiment of FIG. 1.

The different features of the individual exemplary embodiments can also be combined with one another.

The exemplary embodiments of FIGS. 1 to 2 especially have no limiting character and serve to illustrate the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A segmented electrical feedthrough configured to electrically contact a heating conductor through a housing, comprising:
an insulating portion, wherein the insulating portion comprises:
an outer sleeve;
an electrical conductor arranged within the outer sleeve; and
an insulator arranged within the outer sleeve that electrically insulates the electrical conductor with respect to the outer sleeve; and
a heating conductor having a recess into which the electrical conductor is introduced to connect the heating conductor to the electrical conductor at a predefinable angle;
wherein the heating conductor and the insulating portion are formed from different elements that are permanently connected to one another by a joining method.

12. The segmented electrical feedthrough as claimed in claim 11, wherein the heating conductor has a solder reservoir within the recess.

13. The segmented electrical feedthrough as claimed in claim 12,
wherein the recess is formed by a hole,
wherein the solder reservoir is formed on an end face of the hole, which is formed in the heating conductor.

14. The segmented electrical feedthrough as claimed in claim 13, wherein the recess tapers conically from an opening to the end face of the hole.

15. The segmented electrical feedthrough as claimed in claim 11, wherein a central axis of the heating conductor is arranged at an angle of 60 degrees to 120 degrees with respect to a central axis of the electrical conductor.

16. The segmented electrical feedthrough as claimed in claim 11, wherein the electrical conductor is divided, at least in two parts.

17. The segmented electrical feedthrough as claimed in claim 16, wherein the at least two parts of the electric conductor are configured to be inserted into one other and are to be permanently connected to one other by a joining method.

18. The segmented electrical feedthrough as claimed in claim 17, wherein at least one of the at least two parts of the electrical conductor has a solder reservoir, wherein the solder reservoir is arranged in an area at which the two parts of the electrical conductor are in contact with one another.

19. The segmented electrical feedthrough as claimed in claim 18, wherein the solder reservoir is large enough for the two parts of the electrical conductor to be able to be soldered to one another over an entire surface.

20. The segmented electrical feedthrough as claimed in claim 15, wherein the central axis of the heating conductor is arranged at an angle of substantially 90 degrees, with respect to the central axis of the electrical conductor.

21. A method for installing a segmented electrical feedthrough having:
an insulating portion, wherein the insulating portion comprises:
an outer sleeve;
an electrical conductor comprising at least two parts and arranged within the outer sleeve; and
an insulator arranged within the outer sleeve that electrically insulates the electrical conductor with respect to the outer sleeve; and
a heating conductor having a recess into which the electrical conductor is introduced to connect the heating conductor to the electrical conductor at a predefinable angle, the method comprising:
fixing the at least two parts of the electrical conductor with respect to one another by a welding method; and
connecting the heating conductor and the insulating portion, which are formed from different elements, permanently to one another by a downstream soldering method.
